(19) United States
(12) Patent Application Publication
(10) Pub. No.: US 2007/0036466 A1
(43) Pub. Date: Feb. 15, 2007

(54) Estimating an edge orientation

(76) Inventor: Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,629

(22) PCT Filed: May 13, 2004
(86) PCT No.: PCT/IB04/50670

§ 371 Date: Nov. 17, 2005

(30) Foreign Application Priority Data
May 20, 2003 (EP) 03101427.7

(51) Int. Cl. G06K 9/36

(52) U.S. Cl. 382/289

(57) ABSTRACT

A method of estimating an edge orientation located in a neighborhood of a particular pixel (100) of an image is disclosed. The method comprises creating a set of candidate edge orientations; evaluating the candidate edge orientations by means of computing for each of the candidate edge orientations a match error for a corresponding pair of groups (104, 106) of pixels, on basis of a difference between pixel values of the two groups (104, 106) of the corresponding pair of groups of pixels; and selecting a first one of the candidate edge orientations from the set of candidate edge orientations on basis of the respective match errors and assigning the first one of the candidate edge orientations to the particular pixel (100). An advantage of the method is that a relatively low number of computations is required. This is achieved because creating the set of candidate edge orientations is based on previous computations.

The invention relates to a method of estimating an edge orientation in an image, the edge being located in a neighborhood of a particular pixel of the image, the method comprising:

creating a set of candidate edge orientations;

evaluating the candidate edge orientations by means of computing for each of the candidate edge orientations a match error for a corresponding pair of groups of pixels, the match error being based on a difference between pixel values of the two groups of the corresponding pair of groups of pixels, the locations of the two groups of pixels relative to the particular pixel being related to the candidate edge orientation under consideration; and

selecting a first one of the candidate edge orientations from the set of candidate edge orientations on basis of the respective match errors and assigning the first one of the candidate edge orientations to the particular pixel.

The invention further relates to an edge orientation estimation unit for estimating an edge orientation in an image, the edge being located in a neighborhood of a particular pixel of the image, the edge orientation estimation unit comprising:

creating means for creating a set of candidate edge orientations;

evaluating means for evaluating the candidate edge orientations by means of computing for each of the candidate edge orientations a match error for a corresponding pair of groups of pixels, the match error being based on a difference between pixel values of the two groups of the corresponding pair of groups of pixels, the locations of the two groups of pixels relative to the particular pixel being related to the candidate edge orientation under consideration; and

selecting means for selecting a first one of the candidate edge orientations from the set of candidate edge orientations on basis of the respective match errors and for assigning the first one of the candidate edge orientations to the particular pixel.

The invention further relates to an image processing apparatus comprising:

receiving means for receiving a signal corresponding to a sequence of input images; and

an image processing unit for computing a sequence of output images on basis of the sequence of input images, the image processing unit being controlled by an edge orientation estimation unit as described above.

The invention further relates to a computer program product to be loaded by a computer arrangement, comprising instructions to estimate an edge orientation in an image, the edge being located in a neighborhood of a particular pixel of the image, the computer arrangement comprising processing means and a memory, the computer program product, after being loaded, providing said processing means with the capability to carry out:

creating a set of candidate edge orientations;

evaluating the candidate edge orientations by means of computing for each of the candidate edge orientations a match error for a corresponding pair of groups of pixels, the match error being based on a difference between pixel values of the two groups of the corresponding pair of groups of pixels, the locations of the two groups of pixels relative to the particular pixel being related to the candidate edge orientation under consideration; and

selecting a first one of the candidate edge orientations from the set of candidate edge orientations on basis of the respective match errors and assigning the first one of the candidate edge orientations to the particular pixel.

An embodiment of the image processing apparatus of the kind described in the opening paragraph is known from U.S. Pat. No. 5,019,903. This patent specification discloses an apparatus for spatially interpolating between lines of a digital video signal to produce interpolated lines. The apparatus comprises a super sampler being arranged to horizontally interpolate between samples of the signal to produce a super sampled signal consisting of the original samples and interpolated samples located between them. Block matching circuits each determine, for each sample of the super sampled signal, the extent of matching between two blocks of N×M samples (N=number of lines and M=number of samples), the blocks being vertically offset in opposite directions with respect to a line to be interpolated, and being horizontally offset in opposite directions with respect to a predetermined sample position. Each block matching circuit produces a match error for a respective different horizontal offset. A selector responds to the match errors to select, for each sample of the line to be interpolated, from a set of gradient-vectors associated with the different offsets, the gradient-vector associated with the offset that produces the best matching between the blocks. It is assumed that this gradient-vector corresponds to an edge orientation. A variable direction spatial interpolator spatially interpolates the video signal, its direction of interpolation being controlled for each sample it generates, in accordance with the gradient-vector selected for the predetermined sample position corresponding to that generated sample.

A disadvantage of the known image processing apparatus is that a relatively large number of computations are required for determining the orientations of edges in the image being represented by the video signal. For each sample the match errors have to be computed for all offsets, corresponding to the different gradient-vectors to be evaluated.

It is an object of the invention to provide a method of the kind described in the opening paragraph, which requires a relatively low number of computations.

This object of the invention is achieved in that creating the set of candidate edge orientations is based on previous computations. By making use of previous computations, the number of evaluations of candidate edge orientations for a particular pixel is strongly reduced, because fewer candidate edge orientations are required. There are several types of previous computations. A number of these are explained in the dependent claims.

In an embodiment of the method according to the invention the set of candidate edge orientations is created by selecting the candidate edge orientations from a further set of edge orientations, the further set of edge orientations comprising further edge orientations which have been assigned to other pixels of the image after previous edge orientation estimations. In this embodiment according to the invention reuse is made of edge orientations that have been estimated in a spatial environment of the particular pixel and assigned to pixels. The assumption is that edges in an image might overlap with, i.e. extend over multiple pixels. If a particular edge orientation has been assigned to neighboring pixels, then this particular edge orientation is a good candidate edge orientation for the particular pixel under consideration. Hence, an advantage of this embodiment is that the set of candidate edge orientations is limited, resulting in a lower number of computations. Another advantage is that the consistency of estimated edge orientations is improved.

Preferably, selecting a second one of the candidate edge orientations from the further set of edge orientations is based on:

The second one of the candidate edge orientations; and

On the position of a first one of the other pixels to which the second one of the candidate edge orientations has been assigned, relative to the particular pixel. That means that if the second one of the candidate edge orientations substantially matches with a line segment from the first one of the other pixels and the particular pixel then the second one of the candidate edge orientations will be selected. The opposite is also true: if a third one of the candidate edge orientations is not substantially equal to a line segment from a second one of the other pixels, to which the third one of the candidate edge orientations has been assigned, and the particular pixel, then the third one of the candidate edge orientations will not be selected. In other words, the set of candidate edge orientations mainly comprises candidate edge orientations that have a relatively high probability of being appropriate for the particular pixel.

In an embodiment of the method according to the invention the set of candidate edge orientations is created by selecting the candidate edge orientations from a further set of edge orientations, the further set of edge orientations comprising further edge orientations which have been assigned to a further pixel of a further image, after a previous edge orientation estimation, the image and the further image both belonging to a single sequence of video images. In this embodiment according to the invention reuse is made of edge orientations that have been estimated in a temporal environment of the particular pixel and assigned to temporally neighboring groups of pixels. The assumption is that subsequent images of a sequence of video images match relatively well with each other. If a particular edge orientation has been assigned to a corresponding pixel in a previous image, then this particular edge orientation is a good candidate edge orientation for the particular pixel under consideration. Hence, an advantage of this embodiment is that the set of candidate edge orientations is limited, resulting in a lower number of computations. Another advantage is that the consistency of estimated edge orientations is improved.

In another embodiment of the method according to the invention, the creation of the set of candidate edge orientations comprises:

Computing an initial estimate of the edge orientation;

Creating the candidate edge orientations on basis of the initial estimate of the edge orientation and a predetermined threshold.

In this embodiment according to the invention, first an initial estimate of the edge orientation is computed and based on that computation the eventual candidate edge orientations are created. That means that the eventual candidate edge orientations are in a limited range around the initial estimate.

Preferably, the computation of the initial estimate of the edge orientation comprises:

Computing a first sum of differences between pixel values of two blocks of pixels which have opposite horizontal offsets relative to the particular pixel;

Computing a second sum of differences between pixel values of two blocks of pixels which have opposite vertical offsets relative to the particular pixel; and

Determining the initial estimate of the edge orientation by means of computing a quotient of the first sum of differences and the second sum of differences. An advantage of this embodiment according to the invention is that the computation of the initial estimate is relatively robust. This fact can be applied in a number of ways. First, the computation of the actual edge orientation can be performed with a limited set of candidate edge orientations. Alternatively, a relatively accurate edge orientation, i.e. well matching, can be found by applying a number of “sub-pixel” accurate candidate edge orientations. Optionally the first and second sum of differences are respective weighted sum of differences.

In an embodiment of the method according to the invention the first one of the candidate edge orientations is assigned to a block of pixels comprising the particular pixel. An advantage of this embodiment according to the invention is that the number of evaluations of sets of candidate edge orientations is relatively low. Assume that a typical block of pixels comprises 8*8 pixels then the number of evaluations is reduced with a factor 64, since the estimated edge orientations are assigned to 64 pixels instead of to individual pixels. It should be noted that this measure, i.e. assigning the estimated edge orientation to multiple pixels of a block of pixels, is also applicable independent of the measure of creating the set of candidate edge orientations on basis of previous computations, as claimed in claim 1. With this measure alone, the said object of the invention is achieved too.

In an embodiment of the method according to the invention, other edge orientations are assigned to other blocks of pixels of the image on basis of other edge orientation estimations for the other blocks of pixels and that final edge orientations are computed for the individual pixels of the image by means of block erosion. Block erosion is a known method to compute different values for the pixels of a particular block on basis of the value of the particular block of pixels and values of neighboring blocks of pixels. Block erosion is e.g. disclosed in the U.S. Pat. No. 5,148,269. An advantage of this embodiment according to the invention is that with a relatively few computations edge orientations are computed for the individual pixels of the image.

In an embodiment of the method according to the invention, the match error is based on the sum of absolute differences between respective pixels of the two groups of pixels. This match error is a relatively good measure for establishing a match between image parts and which does not require extensive computations. Optionally the two groups are partially overlapping. Besides that sub-sampling might be applied.

In an embodiment of the method according to the invention, the groups of pixels are respective rectangular blocks of pixels. A typical block of pixels comprises 8*8 or 4*4 pixels. In general, block-based image processing matches well with memory access. Hence, memory bandwidth usage is relatively low.

In another embodiment of the method according to the invention, the groups of pixels are respective trapezium shaped blocks of pixels of which the actual shapes depend on the candidate edge orientation under consideration.

It is a further object of the invention to provide an edge orientation estimation unit of the kind described in the opening paragraph, which is arranged to estimate the edge orientation with a relatively low number of computations.

This object of the invention is achieved in that the creating means are arranged to create the set of candidate edge orientations on basis of previous computations.

It is a further object of the invention to provide an image processing apparatus of the kind described in the opening paragraph, which is arranged to estimate the edge orientations with a relatively low number of computations.

This object of the invention is achieved in that the creating means of the edge orientation estimation unit are arranged to create the set of candidate edge orientations on basis of previous computations.

The image processing apparatus may comprise additional components, e.g. a display device for displaying the output images. The image-processing unit might support one or more of the following types of image processing:

De-interlacing: Interlacing is the common video broadcast procedure for transmitting the odd or even numbered image lines alternately. De-interlacing attempts to restore the full vertical resolution, i.e. make odd and even lines available simultaneously for each image;

Image rate conversion: From a series of original (interlaced) input images a larger series of (interlaced) output images is calculated. Interpolated output images are temporally located between two original input images;

Spatial image scaling: From a series of original input images a series of output images is computed which have a higher spatial resolution than the input images.

Noise reduction: Knowledge of the orientation of edges is important to control the interpolation. This can also involve temporal processing, resulting in spatial-temporal noise reduction; and

Video compression, i.e. encoding or decoding, e.g. according to the MPEG standard.

The image processing apparatus might e.g. be a TV, a set top box, a VCR (Video Cassette Recorder) player, a satellite tuner, a DVD (Digital Versatile Disk) player or recorder.

It is a further object of the invention to provide a computer program product of the kind described in the opening paragraph, which requires a relatively low number of computations.

This object of the invention is achieved in that creating the set of candidate edge orientations is based on previous computations.

Modifications of the method and variations thereof may correspond to modifications and variations thereof of the edge orientation estimation unit, the image processing apparatus and the computer program product described.

These and other aspects of the method, of the edge orientation estimation unit, of the image processing apparatus and of the computer program product according to the invention will become apparent from and will be elucidated with respect to the implementations and embodiments described hereinafter and with reference to the accompanying drawings, wherein:

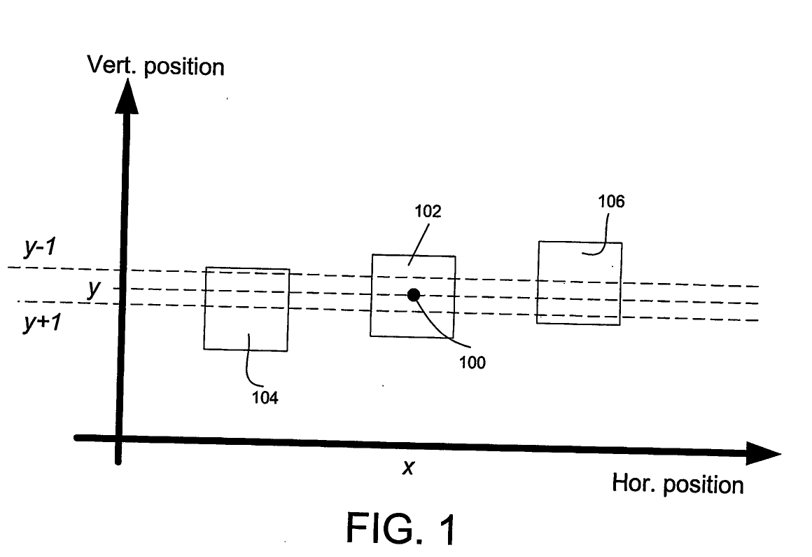

FIG. 1 schematically shows two blocks of pixels that are used to evaluate a candidate edge orientation of a particular pixel;

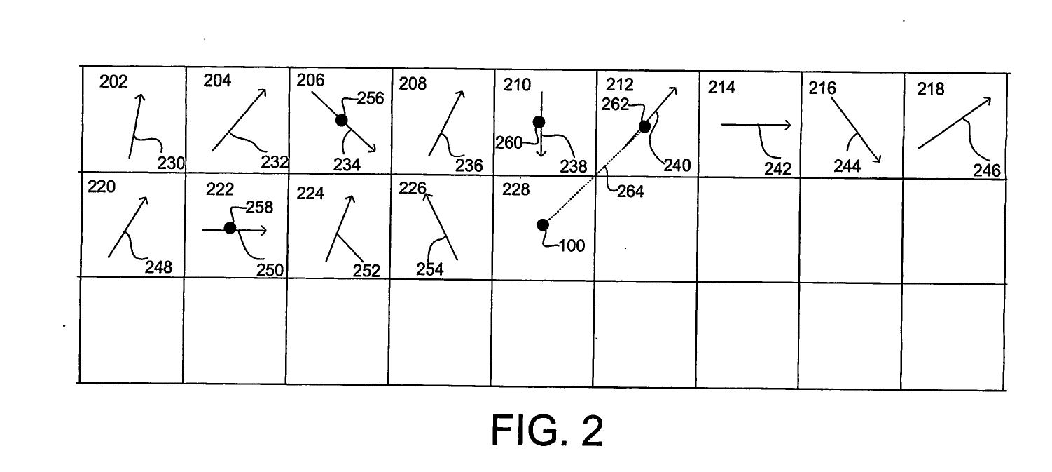

FIG. 2 schematically shows the selection of a number of candidate edge orientations on basis of edge orientations being previously estimated in a spatial environment of the particular pixel;

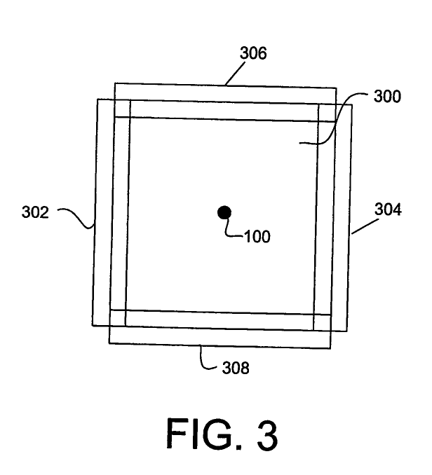

FIG. 3 schematically shows the two pairs of blocks of pixels that are used to compute an initial estimate of the edge orientation;

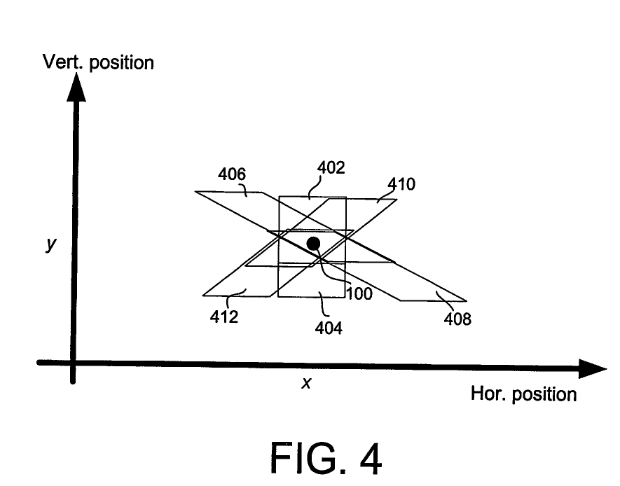

FIG. 4 schematically shows pairs of trapezium shaped blocks of pixels that are used to compute match errors of respective candidate edge orientations;

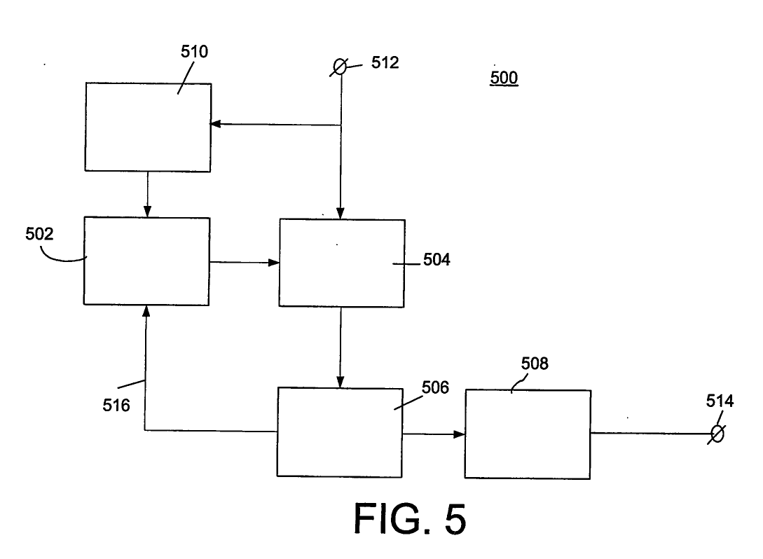

FIG. 5 schematically shows an embodiment of the edge orientation estimation unit according to the invention;

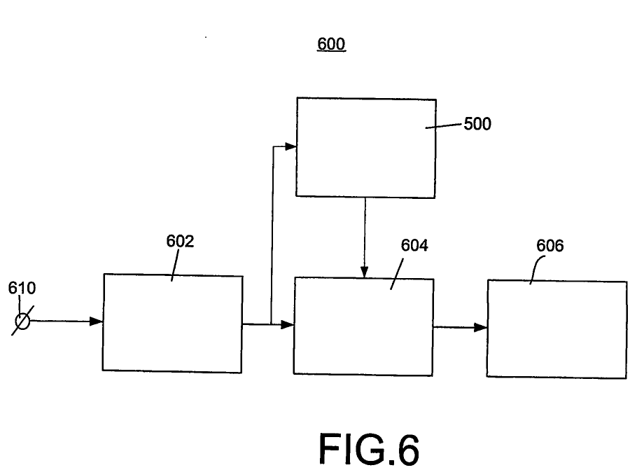

FIG. 6 schematically shows an embodiment of the image processing apparatus according to the invention; and

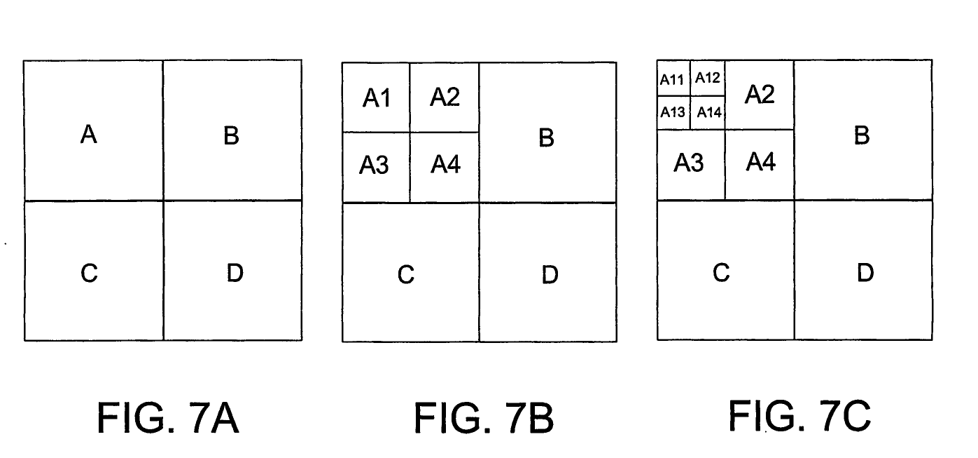

FIGS. 7A, 7B and 7C schematically show block erosion.

Same reference numerals are used to denote similar parts throughout the Figs.

FIG. 1 schematically shows two blocks 104, 106 of pixels which are used to evaluate a candidate edge orientation of a particular pixel 102 in a block B(\vec{X}) 102 of pixels with position \vec{X}. The evaluation of the candidate edge orientation is based on the computation of the Summed Absolute Difference (SAD) as matching criterion. Alternative, and equally well suitable match criteria are for instance: Mean Square Error, Normalized Cross Correlation, Number of Significantly Different Pixels, etcetera. The computation of the match error for a particular candidate edge orientation tngtc is e.g. as specified in Equation 1:

$$SAD ( tngtc , \vec{X} , n ) = {\sum }_{ \vec{x} ∈ B ( \vec{X} )} \vert \begin{matrix}F ( x - tngtc , y + 1 , n ) - \\ F ( x + tngtc , y - 1 , n )\end{matrix} \vert , \qquad ( 1 )$$

where, \vec{x}=(x,y), F(\vec{x},n) is the luminance signal, and n the image or field number. The candidate edge orientation under test, taken from a candidate set CS, can have an integer as well as a sub-pixel value. The edge orientation that results at the output is the candidate edge orientation that gives the lowest SAD value. That candidate edge orientation is assigned to the particular pixel and preferably to all pixels of the block 102 of pixels.

Assuming that the candidate set is specified by Equation 2, and a half-pixel accuracy is sufficient for most applications, some 30 candidate edge orientations have to be evaluated.
CS={tngtc|−8<tngtc<8}, (2)
However according to the invention the number of candidate edge orientations can be reduced an order of magnitude using prediction or recursion. Good results were achieved with the candidate set as specified in Equation 3:
CS(\vec{X},n)={tngtc(n)|tngt(\vec{X},n−1)−1, (3)
tngt(\vec{X},n−1),tngt(X,n−1)+1}
where tngt(\vec{X}, n−1) is the result edge orientation obtained for position X in the previous image n−1. (For simplicity integer accuracy is assumed). Experiments indicate that this is not only attractive from a complexity point of view, but also leads to an increased consistency of the edge orientation. Optionally a (pseudo-noise) update added to a prediction, tngt(\vec{X}, n−1), is realized, next to the prediction itself.

FIG. 2 schematically shows the selection of a number of candidate edge orientations on basis of edge orientations 230-254 being previously estimated in a spatial environment of the particular pixel 100. These previously estimated orientations 230-254 have been assigned to respective blocks 202-226 of pixels. Particularly for fast moving sequences, where a temporal prediction may not lead to convergence to the correct edge orientation, spatial predictions, e.g. edge orientations already assigned to other parts of the same image would be advantageous. In a preferred embodiment, it is possible to distinguish promising predictions based on their value and their position. In other words, selecting of a candidate edge orientation from the set of edge orientations being already assigned to other parts of the same image is based on the value of the candidate edge orientation and on the position of a pixel to which the candidate edge orientation has been assigned, relative to the particular pixel 100. E.g. if to a diagonally neighboring block 212 of pixels an edge orientation of 45° (tngtc=1) has been assigned, this is a promising prediction for the current block 228 of pixels assuming that the edge extends over a larger image part. This becomes clear when the edge orientation 240, which is assigned to the diagonally located block 212 of pixels is compared with the line segment 264 from the particular pixel 100 to a central pixel 262 of the diagonally located block 212 of pixels. Similarly, if a block 206 of pixels at the position (−2, 1) at the block grid has assigned a value tngtc=−2, this is a promising candidate edge orientation for the current block 228 of pixels. Further promising candidates are the edge orientations 238, 246 and 250 which are assigned to the blocks 210, 218 and 222 of pixels, respectively. More formally:

$$tgntc = \{ \begin{matrix}i , & tgnt ( \vec{X} + ( \begin{matrix}\pm i \\ ∓ 1\end{matrix} ) ) = i \\ tgnt ( \vec{X} , n - 1 ) , & else\end{matrix} \qquad ( 4 )$$

There is a chance that the upper term of Equation 4 is true for more than one value of i. In that case preferably tngtc is assigned to the i with the lowest absolute value. A means to achieve this, is illustrated with the following piece of pseudo-code:

if(tgnt [−1,+1] == +1) tgntc = +1;
else if(tgnt [−1,−1] == −1) tgntc = −1;
else if(tgnt [+1,−1] == +1) tgntc = +1;
else if(tgnt [+1,+1] == −1) tgntc = −1;
else if(tgnt [−1,+2] == +2) tgntc = +2;
else if(tgnt [−1,−2] == −2) tgntc = −2;
else if(tgnt [+1,−2] == +2) tgntc = +2;
else if(tgnt [+1,+2] == −2) tgntc = −2;
else if(tgnt [−1,+3] == +3) tgntc = +3;
else if(tgnt [−1,−3] == −3) tgntc = −3;
else if(tgnt [+1,−3] == +3) tgntc = +3;
else if(tgnt [+1,+3] == −3) tgntc = −3;
else if(tgnt [−1,+4] == +4) tgntc = +4;
else if(tgnt [−1,−4] == −4) tgntc = −4;
else if(tgnt [+1,−4] == +4) tgntc = +4;

It will be clear that a candidate set CS can comprise both temporal and spatial candidates, i.e. edge orientations being estimated for other images of the same sequence of images and edge orientations for other blocks of the same image.

Optionally penalties are added to the different edge orientation candidates. These penalties might depend on the type of candidate, i.e. temporal or spatial but also on the values of the candidate themselves. E.g. candidate edge orientations with an angle, which is relatively small compared to the horizontal axis, should be updated with a relatively large penalty.

FIG. 3 schematically shows the two pairs of blocks of pixels that are used to compute an initial estimate of the edge orientation for a particular pixel 100. The first pair of blocks of pixels comprises a first block 302 of pixels which is horizontally shifted to the left related to a particular block B(\vec{X}) 300 of pixels with position \vec{X} comprising particular pixel 100 and a second block 304 of pixels which is horizontally shifted to the right related to the particular block 300 of pixels. The second pair of blocks of pixels comprises a third block 306 of pixels which is vertically shifted upwards related to the particular block 300 of pixels and a fourth block 308 of pixels which is vertically shifted downwards related to the particular block 300 of pixels. The applied shifts are typically one pixel. The computation of the initial estimate of the edge orientation comprises:

Computing a first sum of differences S_{H}(B(\vec{X})) between respective pixel values of two blocks 302, 304 of pixels which have opposite horizontal offsets relative to the particular block 300 of pixels, as specified in Equation 5;

Computing a second sum of differences S_{V}(B(\vec{X})) between respective pixel values of two blocks 306, 308 of pixels which have opposite vertical offsets relative to the particular block 300 of pixels, as specified in Equation 6; and

Determining the initial estimate E(B(\vec{X})) of the edge orientation by means of computing a quotient of the first sum of differences and the second sum of differences, as specified in Equation 7.

$$\begin{matrix}{S}_{H} ( B ( \vec{X} ) ) = {\sum }_{\vec{x} ∈ B ( \vec{X} )} F ( \vec{x} - ( 1 , 0 ) ) - F ( \vec{x} + ( 1 , 0 ) ) & ( 5 ) \\ {S}_{V} ( B ( \vec{X} ) ) = {\sum }_{\vec{x} ∈ B ( \vec{X} )} F ( \vec{x} - ( 1 , 0 ) ) - F ( \vec{x} + ( 1 , 0 ) ) & ( 6 ) \\ E ( B ( \vec{X} ) ) = α \frac{{S}_{H} ( B ( \vec{X} ) )}{{S}_{V} ( B ( \vec{X} ) )} & ( 7 )\end{matrix}$$

with α a constant which depends on the amount of shift related to the particular block of pixels B(\vec{X}) 300. To prevent that E(B(\vec{X})) can not be computed because S_{V}(B(\vec{X}))=0, i.e. the denominator equals zero, special precautions should be taken. For example, a very small value is added to S_{V}(B(\vec{X})) before the quotient is computed. Alternatively, S_{V}(B(\vec{X})) is compared with a predetermined threshold. Only if S_{V}(B(\vec{X})) exceeds the predetermined threshold then the quotient is computed. If not, then a default value for E(B(\vec{X})) is set.

Based on the initial estimate the candidate set for the particular block of pixels B(\vec{X}) 300 is defined:
CS(\vec{X},n)={tngtc(n)|E(B(\vec{X}))−T≦tngtc(n)≦E(B(\vec{X}))+T}, (8)
with T a predetermined threshold.

FIG. 4 schematically shows pairs of trapezium shaped blocks 402-412 of pixels that are used to compute match errors of respective candidate edge orientations. The first pair of blocks of pixels comprises a first block 402 of pixels which is vertically shifted upwards related to a particular pixel 100 and a second block 404 of pixels which is vertically shifted downwards related to the particular pixel. The shapes of the first 402 and second 404 blocks of pixels are rectangular because the locations relative to the particular pixel 100 only comprises a vertical component and no horizontal component. The second pair of blocks of pixels comprises a third block 406 of pixels which is vertically shifted upwards and horizontally shifted to the left related to the particular pixel 100 and a fourth block 408 of pixels which is vertically shifted downwards and horizontally shifted to the right related to the particular pixel 100. The shapes of the third 406 and fourth 408 blocks of pixels are trapezium like because the locations relative to the particular pixel 100 comprises both a vertical component and horizontal components. The third pair of blocks of pixels comprises a fifth block 410 of pixels which is vertically shifted upwards and horizontally shifted to the right related to the particular pixel 100 and a sixth block 412 of pixels which is vertically shifted downwards and horizontally shifted to the left related to the particular pixel 100. The shapes of the different blocks of pixels 402-412 are related to the corresponding edge orientations, e.g. with the first pair of blocks of pixels a vertical edge orientation is evaluated.

FIG. 5 schematically shows an embodiment of the edge orientation estimation unit 500 according to the invention, comprising:

A candidate creating unit 502 for creating a set of candidate edge orientations;

An evaluation unit 504 for evaluating the candidate edge orientations by means of computing for each of the candidate edge orientations a match error for a corresponding pair of groups of pixels; and

A selection unit 506 for selecting a first one of the candidate edge orientations from the set of candidate edge orientations on basis of the respective match errors and for assigning the first one of the candidate edge orientations to the particular pixel.

The evaluation unit 504 is arranged to compute the match error based on a difference between pixel values of the two groups of the corresponding pair of groups of pixels, whereby the locations of the two groups of pixels relative to the particular pixel depend on the candidate edge orientation under consideration. The pixel values are provided by means of the input connector 512. Preferably the groups of pixels are blocks of pixels. The shape of these blocks of pixels might be rectangular or have a trapezium shape as described in connection with FIG. 4.

The candidate-creating unit 502 is arranged to create the set of candidate edge orientations on basis of previous computations. Preferably the edge orientation estimation unit 500 comprises the optional connection 516 between the selection unit 506 and the candidate creating unit 502 for providing the candidate creating unit 502 with data related to selected edge orientations, as described in connection with FIG. 1 and FIG. 2. Optionally the edge orientation estimation unit 500 comprises an initial estimation unit 510, which is arranged to compute an initial estimate as described in connection with FIG. 3.

The evaluations of the candidate edge orientations can be performed for individual pixels. However, preferably these evaluations are performed for groups of pixels. As a consequence, one single edge-orientation is assigned by the selection unit 506 to all the pixels of that group. In order to achieve different values of edge orientations for the individual pixels, or alternatively for sub-groups of pixels the edge orientation estimation unit 500 can comprise a block erosion unit 508. The working of this block erosion unit 508 is described in connection with FIGS. 7A-7C.

The edge orientation estimation unit 500 provides a two-dimensional matrix of edge orientations at its output connector 512.

The candidate creating unit 502, the evaluation unit 504, the selection unit 506, the initial estimation unit 510 and the block erosion unit 508 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

FIG. 6 schematically shows an embodiment of the image processing apparatus according to the invention, comprising:

Receiving means 602 for receiving a signal representing input images;

An image processing unit 604 being controlled by

The edge orientation estimation unit 500 as described in connection with FIG. 5; and

A display device 606 for displaying the output images of the image-processing unit 604.

The image-processing unit 604 might be arranged to perform one or more of the following functions: de-interlacing, image rate conversion, spatial image scaling, noise reduction and video compression. The de-interlacing is preferably as described by T. Doyle and M. Looymans, in the article “Progressive scan conversion using edge information”, in Signal Processing of HDTV, II, L. Chiariglione (Ed.), Elsevier Science Publishers, 1990, pp. 711-721.

The signal may be a broadcast signal received via an antenna or cable but may also be a signal from a storage device like a VCR (Video Cassette Recorder) or Digital Versatile Disk (DVD). The signal is provided at the input connector 610. The image processing apparatus 600 might e.g. be a TV. Alternatively the image processing apparatus 600 does not comprise the optional display device but provides the output images to an apparatus that does comprise a display device 606. Then the image processing apparatus 600 might be e.g. a set top box, a satellite-tuner, a VCR player, a DVD player or recorder. Optionally the image processing apparatus 600 comprises storage means, like a hard-disk or means for storage on removable media, e.g. optical disks. The image processing apparatus 600 might also be a system being applied by a film-studio or broadcaster.

FIGS. 7A, 7B and 7C schematically show block erosion, i.e. the working of the block erosion unit 508. In FIG. 7A four blocks A, B, C and D of pixels are depicted. Each of these blocks of pixels comprises e.g. 8*8 pixels. Edge orientations have been assigned by means of the selection unit 506 to each of these blocks of pixels. That means e.g. that all 64 pixels of block A have been assigned the same value V(A) for the edge orientation and all 64 pixels of block B have been assigned the value V(B) for the edge orientation.

Block erosion is performed in order to achieve different values of edge orientations for sub-blocks of pixels. In FIG. 7B is depicted that the block A of pixels of FIG. 7B is divided into four sub-blocks A1, A2, A3 and A4. For each of these sub-blocks of (e.g. 4*4) pixels the value of the edge orientation is computed on basis of the value V(A) of the edge orientation of the parent block A of pixels and on basis of the values of the edge orientations of the neighboring blocks of pixels of the parent block A of pixels. For example the value V(A4) of the edge orientation of the sub-block A4 is computed on basis of the value V(A) of the edge orientation of the parent block A of pixels the values V(B) and V(C) of the edge orientations of the neighboring blocks B and C of pixels of the parent block A of pixels. This computation might be as specified in Equation 9:
V(A4)=median(V(A),V(B),V(C)) (9)

Preferably the block erosion is performed hierarchically. In FIG. 7C is depicted that the sub-block A1 of pixels of FIG. 7B is divided into four sub-blocks A11, A12, A13 and A14. For each of these sub-blocks of (e.g. 2*2) pixels the value of the edge orientation is computed on basis of the value V(A1) of the edge orientation of the parent sub-block A1 of pixels and on basis of the values of the edge orientations of the neighboring blocks of pixels of the parent sub-block A1 of pixels. For example the value V(A14) of the edge orientation of the sub-block A14 is computed on basis of the value V(A1) of the edge orientation of the parent sub-block A of pixels and the values V(A2) and V(A3) of the edge orientations of the neighboring sub-blocks A2 and A3 of pixels of the parent sub-block A1 of pixels. This computation might be as specified in Equation 10:
V(A14)=median(V(A1),V(A2),V(A3)) (10)

It will be clear that further division into sub-blocks might be applied.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. Method of estimating an edge orientation in an image, the edge being located in a neighborhood of a particular pixel (100) of the image, the method comprising:
creating a set of candidate edge orientations;
evaluating the candidate edge orientations by means of computing for each of the candidate edge orientations a match error for a corresponding pair of groups (104, 106) of pixels, the match error being based on a difference between pixel values of the two groups (104, 106) of the corresponding pair of groups of pixels, the locations of the two groups (104, 106) of pixels relative to the particular pixel (100) being related to the candidate edge orientation under consideration; and
selecting a first one of the candidate edge orientations from the set of candidate edge orientations on basis of the respective match errors and assigning the first one of the candidate edge orientations to the particular pixel (100), characterized in that creating the set of candidate edge orientations is based on previous computations.

2. A method as claimed in claim 1, characterized in that the set of candidate edge orientations is created by selecting the candidate edge orientations from a further set of edge orientations, the further set of edge orientations comprising further edge orientations (230-254) which have been assigned to other pixels of the image after previous edge orientation estimations.

3. A method as claimed in claim 2, characterized in that selecting a second (240) one of the candidate edge orientations from the further set of edge orientations (230-254) is based on:
the second (240) one of the candidate edge orientations; and
on the position of a first (262) one of the other pixels to which the second (240) one of the candidate edge orientations has been assigned, relative to the particular pixel (100).

4. A method as claimed in claim 1, characterized in that the set of candidate edge orientations is created by selecting the candidate edge orientations from a further set of edge orientations, the further set of edge orientations comprising further edge orientations which have been assigned to a further pixel of a further image, after a previous edge orientation estimation, the image and the further image both belonging to a single sequence of video images.

5. A method as claimed in claim 1, characterized in that creating the set of candidate edge orientations comprises:
computing an initial estimate of the edge orientation;
creating the candidate edge orientations on basis of the initial estimate of the edge orientation and a predetermined threshold.

6. A method as claimed in claim 5, characterized in that computation of the initial estimate of the edge orientation comprises:
computing a first sum of differences between pixel values of two blocks (302-304) of pixels which have opposite horizontal offsets relative to the particular pixel (100);
computing a second sum of differences between pixel values of two blocks (306-308) of pixels which have opposite vertical offsets relative to the particular pixel (100); and
determining the initial estimate of the edge orientation by means of computing a quotient of the first sum of differences and the second sum of differences.

7. A method as claimed in claim 1, characterized in that the first one of the candidate edge orientations is assigned to a block (102) of pixels comprising the particular pixel (100).

8. A method as claimed in claim 7, characterized in that other edge orientations are assigned to other blocks of pixels of the image on basis of other edge orientation estimations for the other blocks of pixels and that final edge orientations are computed for sub-blocks of pixels of the image by means of block erosion.

9. A method as claimed in claim 1, characterized in that the match error is based on the sum of absolute differences between respective pixels of the two groups (104, 106) of pixels.

10. A method as claimed in claim 1, characterized in that the groups (104, 106) of pixels are respective rectangular blocks of pixels.

11. A method as claimed in claim 1, characterized in that the groups (402-412) of pixels are respective trapezium shaped blocks of pixels of which the actual shapes depend on the candidate edge orientation under consideration.

12. An edge orientation estimation unit (500) for estimating an edge orientation in an image, the edge being located in a neighborhood of a particular pixel (100) of the image, the edge orientation estimation unit (500) comprising:
creating means (502) for creating a set of candidate edge orientations;
evaluating means (504) for evaluating the candidate edge orientations by means of computing for each of the candidate edge orientations a match error for a corresponding pair of groups (104, 106) of pixels, the match error being based on a difference between pixel values of the two groups (104, 106) of the corresponding pair of groups (104, 106) of pixels, the locations of the two groups (104, 106) of pixels relative to the particular pixel (100) being related to the candidate edge orientation under consideration; and
selecting means (504) for selecting a first one of the candidate edge orientations from the set of candidate edge orientations on basis of the respective match errors and for assigning the first one of the candidate edge orientations to the particular pixel (100), characterized in that the creating means (510) are arranged to create the set of candidate edge orientations on basis of previous computations.

13. An image processing apparatus (600) comprising:
receiving means (602) for receiving a signal corresponding to a sequence of input images; and
an image processing unit (604) for computing a sequence of output images on basis of the sequence of input images, the image processing unit being controlled by the edge orientation estimation unit (500) as claimed in claim 12.

14. An image processing apparatus (600) as claimed in claim 13, whereby the image processing unit (604) is a de-interlacing unit comprising interpolation means being controlled by the edge orientation estimation unit (500) for estimating an edge orientation in an image, the edge being located in a neighborhood of a particular pixel (100) of the image, the edge orientation estimation unit (500) comprising:
creating means (502) for creating a set of candidate edge orientations;
evaluating means (504) for evaluating the candidate edge orientations by means of computing for each of the candidate edge orientations a match error for a corresponding pair of groups (104, 106) of pixels, the match error being based on a difference between pixel values of the two groups (104, 106) of the corresponding pair of groups (104, 106) of pixels, the locations of the two groups (104, 106) of pixels relative to the particular pixel (100) being related to the candidate edge orientation under consideration; and
selecting means (504) for selecting a first one of the candidate edge orientations from the set of candidate edge orientations on basis of the respective match errors and for assigning the first one of the candidate edge orientations to the particular pixel (100), characterized in that the creating means (510) are arranged to create the set of candidate edge orientations on basis of previous computations.

15. An image processing apparatus (600) as claimed in claim 13, characterized in further comprising a display device (606) for displaying the output images.

16. An image processing apparatus (600) as claimed in claim 15, characterized in that it is a TV.

17. A computer program product to be loaded by a computer arrangement, comprising instructions to estimate an edge orientation in an image, the edge being located in a neighborhood of a particular pixel (100) of the image, the computer arrangement comprising processing means and a memory, the computer program product, after being loaded, providing said processing means with the capability to carry out:
creating a set of candidate edge orientations;
evaluating the candidate edge orientations by means of computing for each of the candidate edge orientations a match error for a corresponding pair of groups (104, 106) of pixels, the match error being based on a difference between pixel values of the two groups (104, 106) of the corresponding pair of groups (104, 106) of pixels, the locations of the two groups (104, 106) of pixels relative to the particular pixel (100) being related to the candidate edge orientation under consideration; and
selecting a first one of the candidate edge orientations from the set of candidate edge orientations on basis of the respective match errors and assigning the first one of the candidate edge orientations to the particular pixel (100), characterized in that creating the set of candidate edge orientations is based on previous computations.
